(19) United States
(12) Patent Application Publication
(10) Pub. No.: US 2016/0264809 A1
(43) Pub. Date: Sep. 15, 2016

(54) Polymeric Positive Temperature Coefficient Composition with Improved Temperature Homogeneity

(71) Applicants: Shuyong Xiao, Dorval (CA); Kai Wu, Dorval (CA)

(72) Inventors: Shuyong Xiao, Dorval (CA); Kai Wu, Dorval (CA)

(73) Assignee: 1-Material Inc, Dorval (CA)

(21) Appl. No.: 14/641,756

(22) Filed: Mar. 9, 2015

(51) Int. Cl. C09D 11/52; H05B 3/14; C08J 7/04; C09D 11/106; C09D 11/037

(52) U.S. Cl. CPC C09D 11/52; C09D 11/106; C09D 11/037; C08J 7/047; H05B 3/146; C08K 3/38

(57) ABSTRACT

The invention provides a carbon-based polymer PTC ink composition with enhanced heating uniformity to reduce the risk of hot spots across the PTC thick film fabricated from the PTC ink by addition of boron nitride. The added boron nitride is thermo-conductor and electric non-conductor. The presentation of boron nitride in carbon-based polymeric PTC film improves the temperature homogeneity across the film and maintains the desired PTC effect of the heating device. The content of boron nitride based on the total PTC composition in the invented PTC ink composition is 10-50 wt. %.

### TECHNICAL FIELD

The present invention relates to a method for producing a polymer thick film PTC carbon composition, improving the temperature homogeneity of the polymer thick film.

### BACKGROUND ART

PTC is abbreviation of Positive Temperature Coefficient, which refers to a material that experiences an increase in electrical resistance when its temperature is raised. The PTC effect is technically expressed by Temperature Coefficient Ratio (TCR) defined by the ratio between the resistance at a higher temperature (R^{HT}) and the resistance at a lower temperature (R^{LT}), ie, TCR=R^{HT}/R^{LT}. A conductive polymeric composition exhibiting PTC effect and a device using the same have been used in many applications, especially in electronic industries, including their uses as constant temperature heaters, over current regulators, and low-power circuit protectors. Reference may be made, for example, to U.S. Pat. Nos. 5,714,096 and 5,093,036, and US patent publication numbers: 2013/0193384A1 and 2006/0043343A1.

Of variety of PTC heating devices disclosed, the polymeric thick film made from a carbon-based PTC ink composition is of more potential in practical commercial applications since such a film can be produced by conventional printing technologies. A typical PTC heater based on the polymer thick film PTC carbon compositions can be configured by many electric thermo-resistor units in parallel or in serial to have the designed heating energy density. Each thermo-resistor unit, as shown in FIG. 1, include two electrodes, most printed silver buses and a printed PTC resistive strip with a resistance (R) sandwiched between two electrodes. Upon applying an voltage (V) between the electrodes, an electric current (A) passes through the PTC resistive strip, yields an electric heating power output (W), following the ohm law: that is the output Power (W)=Current (A)×Voltage (V) and the Current (A)=Voltage (V)/Resistance (R), or W=V²/R. Under an output heating power, the temperature of the heating unit is increased. Due to PTC nature of polymer thick film strip, its resistance is increased along with the increase of temperature, which causes in turn the decrease of output heating power. At a certain temperature, the heating power decreases to a point which just balances the heat loss to its surrounding environment, so the temperature approaches an equilibrium and maintains constantly afterward, thus the PTC heater demonstrates its self-regulating function.

One common problem with current carbon based PTC heaters is the risk of overheating or even melting at certain spots due to heating unevenness and temperature fluctuation across the PTC resistive strip. During transferring a PTC ink onto a substrate by printing, the PTC film formed on the substrate may vary in thickness from a local area to another, and so is the localized sheet resistance, which thus causes the variation of the heating power output at different locations. Because polymeric carbon thick film is not a thermo-conducting composition, the location or spot with a higher localized heating power sequentially causes a sharp temperature rising at that spot. As a consequence, such a sharp temperature rising creates a hot spot and even potentially causes this hot spot melt down or burnt out, which ultimately makes the heating unit un-functional. Obviously, such a potential risk of hot melting spot becomes a factor which seriously restricts the application of polymer thick film PTC technology in a practical commercial applications.

The simple way to over-counter the problem of potential and dangerous hot melted spot is to shorten the distance between two electrodes (silver buses). However, such a configuration with short distance between silver buses implies more silver buses required in a given area, and results in a higher cost due to its high silver consumption.

Therefore, it is ultimately demanded to improve the heating evenness carbon-based PTC polymeric thick film. This is the objective of the present invention, which provides a method to improve the thermal conductivity of polymeric PTC carbon composition by adding thermally conductive and electrically non-conductive component, simply referred as thermo-conductor hereinafter.

### SUMMARY OF THE INVENTION

The present invention invents an additional component into prior-art PTC inks and into the PTC films created from these PTC inks. The invented additional component is thermo-conductor, which enhances the temperature homogeneity of the PTC film while maintains the desired electric properties, in particularly the desired PTC behavior. The preferable thermo-conductor is Boron Nitride (BN), in an amount that improves the thermal conductivity of the PTC composition as compared to compositions that do not contain such a thermo conductor in prior arts. Boron nitride (BN) is often referred to as “white graphite” because it is a lubricious material with the same platy hexagonal structure as carbon graphite. Unlike graphite, BN is a very good electrical insulator, which has little or no effect on the electronic properties, in particularly the PTC behaviors of the formulated PTC composition. It offers very high thermal conductivity and good thermal shock resistance, which can technically enhance the temperature homogeneity of the formulated polymer PTC film.

Accordingly, the present invention provides a polymeric PTC carbon composition having 10-40 wt. % of boron nitride, 10-40 wt. % of carbon black; 10-40 wt. % of polymeric resin capable of offering the designed PTC effect, 40-80% wt. % of organic medium capable of solubilizing the resin. The invented PTC composition has an improved thermal conductivity as compared to these PTC compositions disclosed in prior art.

### BRIEF DESCRIPTION OF THE DRAWINGS

FIG. 1 illustrates a typical PTC heating unit, consisting two silver buses as electrodes (A and B) and a carbon-based PTC resistive film strip (S) sandwiched between two electrodes (A and B). The length of resistive film strip (S) is the distance between two electrodes, and for expressional proposal, is expressed as X-axis with a relative scale of 100 from one electrode (A) to another electrode (B).

FIG. 2 presents the plot of TCR (TCR: Temperature Coefficient Ratio is defined as the ratio between the resistivity at the given temperature (T ° C.) and the resistivity at the 25° C.) versus temperature for Example 1 (circle) and Example 2 (square).

FIG. 3 presents the temperature profile across the PTC film strip for Example 1 (circle) and Example 2 (square) upon charging an electric voltage of 32 Volts for 2 hours. The X-axis is defined as the same in FIG. 1.

FIG. 4 presents a photographic comparison of the PTC film of Example 1 (right side) and Example 3 (left side) upon charging an electric voltage of 110 Volts for 2 minutes.

### DETAILED DESCRIPTION OF THE INVENTION

A typical polymeric PTC ink composition involves four parts (or components), and these four parts can be functionally classified as (1) the electrically conductive component to provide electric conductivity (2) the polymer component as the binder or adhesive to disperse conductive component and to allow the PTC composition coated on a substrate; (3) the solvent to mix all components together in a liquid or gel form and allows the whole composition to be transferred onto a substrate by convention printing methods (4) the optional one or more additives to assist in stabilizing the ink composition and improving print-ability. In typical application, a PTC ink is printed onto a substrate and then dried at high temperature to remove the solvent, yield a PTC film composing the solid parts of PTC Ink, including electrical conductor, polymer resin and optional additives.

The present invention invents an additional component into typical PTC inks and into the PTC films created from the PTC inks. The invented additional component is a electric non-conductive and thermo-conductive material (refereed as thermo-conductor hereafter), which enhances the temperature homogeneity of the PTC film while maintains the desired electric properties, in particularly the desired PTC behavior. Thus the invented PTC ink composition consists of five parts: thermo-conductor, electrical conductor, polymer resin, solvent media, and optional additives

The thermal conductor in the present invention shall have the desirable thermal conductivity and have no or very low electric conductivity. Such materials include, but are not limited to, AN (Aluminum Nitride), BN (Boron Nitride), MgSiN2 (Magnesium Silicon Nitride), SiC (Silicon Carbide), ceramic-coated graphite, or a combination thereof. The most preferable electrically non-conductive material with high thermal conductivity for the present invention is boron nitride (BN). The boron nitride used in the invention is typically hexagonal boron nitride (h-BN), which can be complete h-BN or turbostratic boron nitride (t-BN). The selected BN can be large sized single BN crystal particles, agglomerate of small sized BN particles, the mixture thereof, the agglomerated spherical powder, or BN fiber. In one aspect, the average BN particle size or D50 in diameter can range from 1 to 500 micrometers. The particle size referred here means the single BN particle or its agglomerate at any of their dimensions. In one aspect, the BN has a BN purity ranging from 95% to 99.8%. In one embodiment, a large single crystal sized flake BN with an average size ranging from 3 to 50 micrometer and a BN purity of over 98% is used. The preferable boron nitride content in the invented PTC ink composition is 10-50 wt. %, and the most preferred boron nitride content in the invented PTC ink composition is 15-30 wt. %.

The electrical conductor in the present invention is preferably a carbon black. The preferable carbon black in the present invention is such a carbon black which offers the desirable conductivity and the desirable PTC effect. Such a carbon is preferable selected from Cabot REGAL 350R, Black Pearls L, Black Pearls 280, Monarch 120, and Monarch 430. Other carbons and/or graphite may be used in combination of conductive carbon black as well as in combination of other electric conductors such as silver, gold and copper. The preferable carbon content in the invented PTC ink composition is 10-50 wt. %, and the most preferred carbon content in the invented PTC ink composition is 15-30 wt. %.

The polymer resin in the invented PTC composition is required to provide the binding function for the carbon black, the adhesion function to the substrate to be coated on, and the desirable PTC function. Such a desirable PTC function may be resulted in the thermo-expansion of the polymer resin and/or its phase changing along the change of temperature such as melting and/or glass transition of the polymer resin. Any polymer resin and a mixture of different polymers can be selected in this invention providing it can provide the three functions listed above.

Specifically, the preferred polymers of this invention include functional polyethylene and vinyl acetate, such as ®Vinnolit PA 5470/5 manufactured by Vinnolit GmbH & Co. KG, Elvax manufactured by Du Pont; chlorinated polyolefin with/without carbonyl groups, or ester groups, or maleic anhydride groups such as CP343 from Eastman; fluorinated polymers such as Kynar 711, Kynar 9300, Kynar 9301 and RC 10,235 from Arkema.

The preferable polymer content in the invented PTC ink composition is 10-50 wt. %, and the most preferred polymer content in the invented PTC ink composition is 15-30 wt. %.

The solvent in the invented PTC ink composition is required to dissolve the selected polymer or a mixture of polymers, and it can also be practically evaporated during drying after the ink coated on a substrate. Therefore, the polarity, which is related to the solubility of the polymer in it, and its boiling point are two factors to be considered for the selection of solvent, and it is recognized by one of skill in the art once the polymer in the invented PTC composition is chosen.

The preferred solvents in the invented PTC composition include kerosene, aromatics, DMF (Dimethylformamide), NMP (N-methyl pyrrolidone), dibasic esters, dibutylphthlate, butyl carbitol, hexylene glycol, high point (170-250° C.) alcohol and alcohol esters, and the like. The most preferable solvent for this invention is dimethylnaphthalene.

The preferable solvent content in the invented PTC ink composition is 30-80 wt. %, and the most preferred solvent content in the invented PTC ink composition is 50-60 wt. %.

The additive in the invented PTC ink composition is optional, which may be added to improve the rheological properties, to enhance the dispersion of carbon black or to increase the ink shelf-life. For examples, the dispersing additives such as BYK-220S and ANTI-TERRA-204 (BYK USA Inc.) can be preferably used. The rheology additives such as BYK-410 or BYK-430 can be preferably used.

Like production of other convenient print-able inks, general composition preparation and printing procedures are known to one skill in art. First, the polymer is dissolved in the solvent with assistance of heating if necessary to have a polymer solution in the concentration of 15-40 wt. % of polymer. Secondly, the thermo-conductor (BN), and the electric conductor (carbon black) and the additive if being chosen are mixed with the polymer solution to yield a coarse paste. Third, the coarse paste is then subjected to milling or grinding to yield a fine paste, Finally, the fine paste is properly let-down with additional polymer solution and other additives if necessary to have the final PTC resistive ink.

The PTC resistive ink thus prepared is coated onto substrates such PET film, polyimide film, ceramic surface, glass, mirror, and other surfaces by conventional screen printing, flexographic printing or gravure printing. The wet film thus coated on the substrate is then dried under heating to remove the solvent and finally yields a solid polymeric film with a film thickness in the order of micrometers (preferably 5-25 micrometers).

In the preparation of an exemplary composition of the invented PTC ink, it is preferably prepared according to the procedure consisting of the following steps.

1) The preparation of 10-30 wt. % polymer solution: For example, 80.0 grams of dimethylnaphthalene is firstly heated to 80° C. and then 20.0 grams of ®Vinnolit PA 5470/5 is added slowly into the solvent. The mixture is heated at 80° C. for 5 hours and results in a light yellow homogenous polymer solution.

2) The preparation of ink base: A dispersing additive 1.0-10.0 wt. % based on the total ink base is firstly added into the above polymer solution under mechanically stirring. Then, the carbon black 30-60 wt. % based on the total ink base is added slowly into the solution under mechanically stirring. Then, the boron nitride 30-60 wt. % based on the total ink base is added slowly into the solution under mechanically stirring to have a coarse paste.

3) Grinding and milling to prepare the fine paste-like ink base: The coarse paste is then subjected to a three-roll mill to assure proper dispersion of the carbon black to form a fine paste-like ink base. During the three-roll milling, a rheology additive 1.0-10.0 wt. % based on the total ink base may be added to enhance the screen-printing properties of the ink base.

4) Let-down to prepare the final PTC ink: The final PTC ink can be obtained by mechanically mixing the above polymer solution and the fine paste-like ink base at certain ratio ranging from 0.5/1 to 1/1. The ratio depends on the application needs such as the desired resistance and printing method.

In the present invention, the resulting PTC ink is used to fabricate a self-regulated heating element. The self-regulated heating element was charged under certain voltage to evaluate the heating uniformity and to monitor whether or not any hot melted spot occurring.

In the present invention, the resulting PTC ink is printed onto a polyester film (DuPont Teijin films) by conventional screen-printing method. After printing the PTC ink onto a polyester film, it is cured in an oven at 120° C. for 10 minutes. Subsequently, a conductive paste suitable for use on polyester substrates such as DuPont 5025 silver paste is printed along/over two opposite edges of the PTC ink strip and cured at 120° C. for 10 minutes to construct electrodes. The resulted PTC heating element is charged by different voltages o evaluate the heating uniformity and to monitor whether or not the hot melted spot occurring across the carbon-based polymeric PTC film.

### EXAMPLES

The present invention will be further described in more details by giving practical examples. The scope of the present invention, however, is not limited to any way by these practical examples. All component concentrations are expressed as parts by weight.

### Patentable Example 1

The PTC ink and film were made following the typical procedure described above. The polymer resin, carbon black, boron nitride, solvent, dispersing additive, and rheology additive used in this example are respectively ®Vinnolit PA 5470/5, MONARCH 120, Thermo Boron Nitride powder (grade: PCTF5), dimethylnaphthalene, BYK-220S, and BYK-410, and their concentration in the final PTC composition is listed in Table-1. Thus, 17 parts of polymer ®Vinnolit PA 5470/5 is first dissolved into 50 parts of the solvent dimethylnaphthalene at 80° C. to have a polymer solution. Half amount (33.5 parts) of the prepared polymer solution is transferred into a metallic container, then 15 parts of Boron Nitride powder (grade: PCTF5), 15 parts of carbon black Monarch 120 and 2 parts of rheology additive BYK-410 were slowly added with a mechanic mixer into this half amount (33.5 parts) of the prepared polymer solution to yield a coarse paste. The coarse paste is then passed a 3-roll mill three times sequentially from large gap to small gap to result in a fine paste. Into this fine paste, the remained half amount (33.5 parts) of the polymer solution and 1 part of dispersion additive, BYK-220S are slowly added under a vigorously agitation with a high-shear mixer to yield the final ink composition Example 1.

TABLE 1
Concentration of each component in the final PTC composition
of examples

| | Example | |
|---|---|---|
| | Example-1 | Example-2 |
| Composition by parts | | |
| Boron Nitride powder (grade: PCTF5) | 15.0 | 0.0 |
| Polymer(Vinnolit PA 5470/5) | 17.0 | 17.0 |
| Carbon black (Monarch 120) | 15.0 | 15.0 |
| Solvent (dimethylnaphthalene) | 50.0 | 50.0 |
| Dispersion additive (BYK-220S) | 1.00 | 1.00 |
| Rheology additive (BYK-410) | 2.00 | 2.00 |
| Electronic Properties | | |
| Initial sheet resistance (KΩ/⋄) at 10μ and 25° C. | 5.0 | 4.6 |
| TCR (R⁶⁵/R²⁵) | 3.98 | 3.78 |
| TCR (R⁸⁵/R²⁵) | 8.35 | 7.88 |

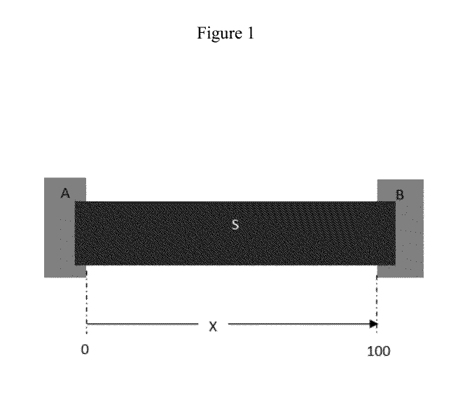

The Example 1 ink is printed onto a polyester films (DuPont Teijin films, ST505) by screen-printing using a 280 mesh polyester screen. After printing, the wet film is cured in an oven at 120° C. for 10 minutes. Subsequently, DuPont 5025 silver paste is printed along the opposite edges of the PTC ink strip, and cured again at 120° C. for 10 minutes to create the testing PTC strip as illustrated in FIG. 1. The initial resistance of the testing strip at 25° C. is measured and recorded as the initial sheet resistance. Further, the test strip is powered at different voltages (5 to 120 V), where the resistance and the temperature were recorded in situ. During the course of electric charging, the temperature homogeneity is closely monitored by temperature sensors located at variety locations across the PTC film strip, and attention is also paid to observe any hot melting spot occurring across the film strip.

### Comparative Example 2

The PTC ink and film were made following the exactly same procedure described as in example 1, however, Boron Nitride powder (grade: PCTF5) is not added in this example, and the final concentration of each component in the PTC composition is also listed in Table-1.

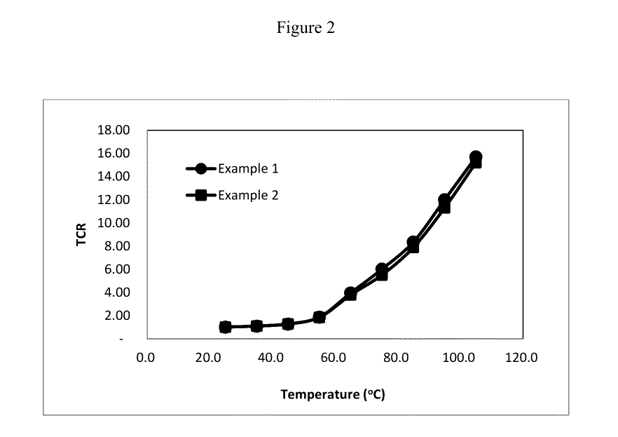

FIG. 2 shows the TCR behavior of Example 1 and Example 2, and demonstrates that the addition of the thermo conductor boron nitride (BN) in Example 1 has virtually no impact on the PTC behavior of the formulated PTC ink comparing to Example 2 without the addition of the thermo conductor boron nitride (BN).

### Comparative Example-3

A self-regulated heating element was fabricated exactly same as Example 1, but from a commercially available LOCTITE ECI 8001 E&C PTC ink (Henkel Co., NV, Belgium) instead of the PTC ink composition of Example 1.

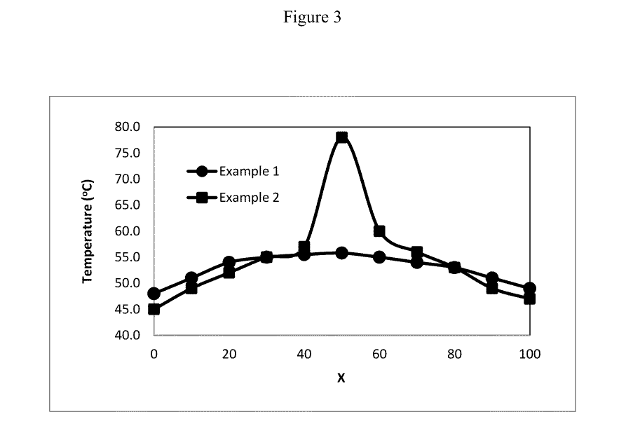

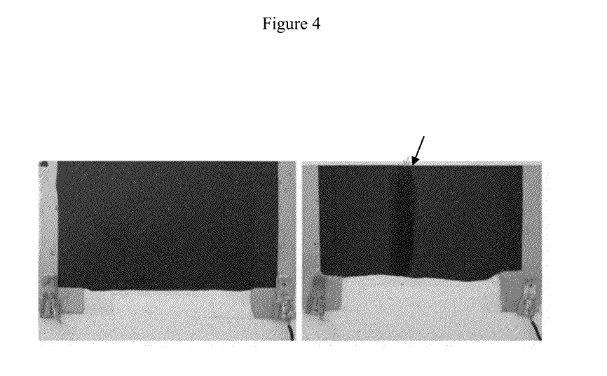

For a comparison, the PTC film of Example 1 of this invention, the PTC film of Example 2 of the prior art and the PTC film of Example-3 of the commercial product, were charged at 110 V at the same time in parallel. As shown in FIG. 3 (Curve), the heating uniformity of the PTC film made from Example 1 of this invention is very much improved comparing to these films made from either Example 2 of the prior art or Example 3 of the commercial product. Furthermore, as shown in FIG. 4, the PTC film of Example 3 of commercial product caused a hot melted spot shortly after applying electric voltage, while no hot spot is observed over the PTC film of Example 1 of this invention.

What is claimed is:

1. A polymeric positive temperature coefficient carbon-based resistor composition, comprising:
(a) 5-20 wt. % of boron nitride, and
(b) 10-40 wt. % of carbon black, and
(c) 10-40 wt. % of polymeric resin, and
(d) 40-80% wt. % of organic solvent capable of solubilizing the polymeric resin.

2. The polymeric positive temperature coefficient carbon-based resistor composition of claim 1, further comprising 0.2-5 wt. % of a dispersing additive.

3. The polymeric positive temperature coefficient carbon-based resistor composition of claim 1, further comprising 1.0-10.0 wt. % of a rheology modifier.

4. The polymeric positive temperature coefficient carbon-based resistor composition of claim 1, wherein the polymeric resin is a chlorinated polyolefin.

5. The polymeric positive temperature coefficient carbon-based resistor composition of claim 1, wherein the polymeric resin is a fluoropolymer.

6. The polymeric positive temperature coefficient carbon-based resistor composition of claim 1, wherein the polymeric resin is a copolymer of vinylidene fluoride and hexafluoropropylene.

7. The polymeric positive temperature coefficient carbon-based resistor composition of claim 1, wherein the polymeric resin is a terpolymer of vinylidene fluoride, hexafluoropropylene and tetrafluoroethylene.

8. The polymeric positive temperature coefficient carbon-based resistor composition of claim 1, wherein the polymeric resin is a mixture of any two polymers of polyurethane, nylon, polyester, fluorinated polymer and poly-acrylic.

9. A positive temperature device comprising the polymeric positive temperature coefficient carbon-based resistor composition of any claims 1-7, wherein the polymeric positive temperature coefficient carbon-based resistor composition has been coated onto a substrate by removing the solvent.
